(19) United States
(12) Patent Application Publication
(10) Pub. No.: US 2007/0130370 A1
(43) Pub. Date: Jun. 7, 2007

(54) Portable search engine

(76) Inventor: Emeka Akaezuwa, Randolph, NJ (US)

Correspondence Address: MICHAEL I KROLL, 171 STILLWELL LANE, SYOSSET, NY, 11791, US

(21) Appl. No.: 11/384,935

(22) Filed: Mar. 20, 2006

Related U.S. Application Data
(60) Provisional application No. 60/742,655, filed on Dec. 6, 2005.

(51) Int. Cl. G06F 3/00; G06F 15/177

(52) U.S. Cl. 710/1; 713/1

(57) ABSTRACT

POSE is a portable search engine that is designed to be a search platform. A search platform is a search engine that runs on all the devices, on all the platforms, parses most of the data formats, regardless of platform and is Unicode-based. POSE runs on portable and miniaturized drives and devices such as portable removable drives, cellular phones, PDAs, nano drives and any device that has a portable hard drive embedded. The idea of POSE is that device, search and data should occupy the same space. In this regard, search moves into the devices rather than stay on the desktop. Moving search into these devices makes search as portable as the data carried on these portable drives and devices. To intelligently manage the flow of information within and among devices and between devices that are connected to public information systems, POSE creates a series of device registries, federation of devices, device knowledgebase and rules files. Collectively these files moderate the exchange of data among devices, identify device owners, define what a device is and what its capabilities are and help to enable data conversion from one device's format to another.

### RELATED APPLICATIONS

This application is subject to U.S. provisional patent application Ser. No. 60/742,655 filed 08 Dec. 2005. Please incorporate by reference all information in said provisional application into this instant application.

### BACKGROUND OF THE INVENTION

The present invention relates generally to computer software and, more specifically, to a portable search engine, hereinafter referred to as POSE, that can be carried or moved with ease and knows the context in which it is operating using an incorporated intelligence layer.

The desktop search engine was designed in the 70s-80s when searchers searched from a fixed location—the desktop. Today we are all mobile searchers. We carry our data with us on portable devices such as flash drives, cell phones, PDAs and a host of other portable information managers. Because our data are increasingly mobile and the information devices we have increasing varied, we need a new search technology that will be as mobile as our data. We also need a search engine that can handle the varied information devices we use. We need to be able to easily search and find the data we produce or stored on the devices we use. We need to be able to find the data when we need the data, regardless of where we are. POSE was conceived in response to these problems.

Benefits of POSE

You can use one search engine to search for information across multiple devices.
POSE has in-built intelligence that allows users to connect to any computer and not have the device share data if the user does not want to share the data on the device.
POSE works on cameras and MP3 players so it makes it easy to download and delete pictures from digital cameras and to move playlists among devices.
By installing the software where the data is, POSE encapsulates search, data and device. This encapsulation makes it easy to find information because the device, search and data are always together.
Federated searching: POSE can search multiple devices or drives simultaneously from one interface.
POSE gives users the ability to use the same search interface to search and retrieve data regardless of which computer the device or drive is connected to.
POSE makes it possible for users to instantly find information regardless of whether they are at home, in the office or on the road. Users can find information easily as soon as they connect the drive to any computer. POSE requires no installation on the host computer.
POSE leaves no trace of a user's file on the host computer that it is connected to because all files are stored on the device.
POSE uses the default browser on the computer the drive is connected to and supports all major browsers, Firefox, Internet Explorer, Netscape, Opera, etc.
POSE is Cross-platform: POSE runs natively on Windows, Linux, Mac and UNIX. The advantage of this is that users who have a mix of Windows, Mac or Linux can have access to all their files using the same software! Users are no longer limited to retrieving their data due to platform incompatibilities.
Automatically categorizes data found on the device.
On-the-fly indexing of documents on portable devices or drives.
Automatic language detection in documents stored on portable devices or drives.

### FIELD OF THE INVENTION

The present invention relates to search software that allows users to install a portable search engine, including an index on any device. The invention provides a search platform that makes it easy for users to search any of their devices using the same search engine regardless of device or the platform the device is running on. This invention encapsulates device, search engine and data and makes it possible to install a search engine on a digital camera instead of on the desktop. The invention includes the identification of and associating devices to owners and to other information devices to maintain privacy of information. In addition, the invention creates a linking and information management layer for portable applications. Users not only search the information on their devices, they also search other sources such as free and paid Websites or databases. POSE creates a linking layer that manages linking to external sources—paid or free.

### SUMMARY OF THE PRESENT INVENTION

Embodiments of the present invention generally provide for a portable search engine and processes that allow the portable search engine to install itself on and to search and display data on any device. The portable search engine is cross-platform, internationalized, distributed and has a federated search engine.

In one embodiment, the POSE is a search platform that allows users to search on any platform using the same search engine. A search platform eliminates the headaches resulting from the fact that users save their data on multiple devices but do not have a search engine that can index and search all the devices they use.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The present invention, Portable Search Engine (POSE), relates to search engine software that can be carried or moved with ease and knows the context in which it is operating. Because it is portable, POSE installs on any device and can be used anywhere, at home in the office or on the road. A device is anything that can store data. Flash drives, portable external drives, cell phones, digital cameras, desktop and laptop computers, MP3 players, wristwatches, home entertainment systems and personal digital assistants (PDAs) are a few examples of devices.

In the near future, portable devices, not desktops, will be the dominant way of creating and storing information. Even today, people use at least 6 devices—a laptop, a desktop, a cell phone, an MP3 player and a PDA, digital camera, or other information managers. Users use these devices to generate data and need a way to search all the devices. And, they need to search them where they use them—on the road, at home or in the office. POSE was invented to enable people to search all the portable devices they use using one search engine.

Characteristics of POSE

POSE is portable so it may be installed on the devices the user has and be searched with ease regardless of where the user is. Unlike the search engines of today that store all their application data and the generated indices on the desktop or on an external server, POSE installs and saves all files relating to a device on the device itself.

POSE is a search platform so that users can search all the devices they own—cell phones, flash drives, digital cameras, personal digital assistants, desktop and laptop computers, etc.—simultaneously. The idea is that the user simply plugs in the device and searches—it does not matter whether the device is a wristwatch, cellphone or home computer.

POSE has an intelligence layer that allows it to know who owns each device so as to know how to behave when used at home or on the road. POSE's intelligence layer comprise of Federation of devices, device registry, device knowledgebase, device rules database, license manager and a connectivity and an e-commerce layer.

The motivation behind the invention of POSE is to solve the “information silo on devices” problem. Users use at least 6 portable devices to create and store information. They use cell phones to store phone numbers, email, application data, Todo lists, pictures and other information. Mp3 players store songs and application data. Digital cameras store pictures. PDAs store contacts, email, application data, pictures and other information. These devices store the same kinds of data but are used primarily for different purposes. Unfortunately, the information created by each device remains a silo on each device. Users want to use the same search engine to search all of their devices. Users also want to use the search engine anywhere they use their devices, not just on the desktop. Unfortunately there has not been such a search engine until POSE.

Because all of these devices have storage that store the same kind of data, though in different ways, POSE's design mandates the storage, not the operating system, as the basic unit of design. Consequently, POSE runs on anything that has storage—it does not matter what kind of storage. POSE then builds a model of a device (see FIG. 3) on the storage framework. With this approach anything can be defined on top of the storage foundation. This is a fundamental departure from the way software is conceived of and built today. Today, software is designed from the point of view of the operating system. In POSE's view, the operating system is one configuration option among many.

POSE is designed as a distributed search engine. This means POSE can install its index on one device and its search engine on another device and still work. There may be times when a user may want to store the generated index from a device on another device.

POSE is a portable meta-search engine. As a portable meta-search engine, POSE can search multiple portable devices simultaneously. Since POSE installs its files on each device, POSE is able to simultaneously search each device when the devices are connected.

POSE is designed to be able to interchange search information on the different operating systems. This means a user can use any device on any operating system and be able to use POSE to search the device. For example, a user can search a UNIX or Macintosh device from Windows using POSE. This is possible if POSE is installed on the UNIX and Macintosh computers and they are all connected via a network.

POSE works on dumb and smart devices. A dumb device is a device that has no processor, system memory, graphics card, networking or display capabilities of its own. An example of a dumb device is an external disk drive. When installed on a dumb device, POSE must be connected to a host in order for it to work. When connected to a host, POSE uses the host's processor, system memory, graphics card, networking and display. When installed on a smart device, POSE uses the smart devices processor, system memory, graphics card, networking and display.

Because it can be used anywhere, POSE needs to have the intelligence to know what to do with regards to exchanging information with the hosts (private or public) it is connected to. A private host is defined broadly to mean a host owned by the person who owns the device. A public host is a host that does not belong to the person who owns the device, for example a computer in an airport or a computer at an Internet Café. POSE has 3 modes of working: Home Mode, Away Mode: Stand-alone mode.

In Home Mode POSE shares data with all the hosts it is connected to. In this mode the host is considered private and POSE has determined that all the connected devices are owned by the same person. POSE uses the information obtained from its device registry to determine whether it is operating in home mode—connected to a host that belongs to the same person who owns the devices that are connected to the host. Even though there may be 6 or more connected devices, only one instance of POSE will be running because POSE automatically handles how many instances are running. In the home mode only one instance will run since all devices belong to the same person and it is all right to see and share all the information on the devices.

Away Mode, Connected: In this mode POSE considers itself in away mode if it does not find the profile of the computer it is running on in its device registry. In this mode, POSE uses the host to create an isolated working environment. POSE runs strictly from the device but uses the host's resources such as the host's monitor, browser, and applications needed to show data but nothing is saved on the host. POSE does not share information with the host. If the host also has POSE installed, the POSE running on the device will not combine its instance with that of the one running on the host. Instead, POSE on the device will run from the device. The reason for this is that the POSE on the public host and the POSE on the device belong to different people.

In Away Mode, Stand-alone: This mode is for smart devices like Smrartphones that have keyboards, memory, processor and display capability. POSE is not connected to any host (private or public) so it depends entirely on the files on the device.

How POSE Works

POSE is installed on each device. During installation, POSE asks the user to give the device a profile name. The user then enters a descriptive name for the device. POSE then queries the device for a unique identifier. For desktops and laptops POSE uses their machine address (MAC ID). For other devices, POSE queries the devices for their vendor ID and serial number. POSE combines the vendor ID and serial number and uses these as a unique identifier for the device. For devices that do not have a MAC address or a vendor ID and serial number, POSE generates a unique number. The unique identifier is then tied to the profile name given to the device and stored in the device registry. POSE searches the device registry for a list of registered devices on startup and if the device's ID is in the registry POSE indexes and searches the device and if not, POSE runs as an independent operating environment and uses the host's memory, processor, keyboard and monitor but does not try to index or search the host.

After entering the device's profile name and unique ID in the device registry, POSE checks the license file to ensure the user's license has not expired and the user has not exceeded their allotted license. If the license is still valid, POSE checks the number of connected devices to make sure that the number of connected devices has not exceeded the number allowed in the license. If the number of connected devices is within limits, POSE checks the device knowledgebase to retrieve information for the device and also checks the rules file associated with the device. After this, POSE installs itself and starts indexing documents or starts monitoring the device for changes if POSE has already been installed. FIG. 5 shows the device registry, the license file, the devices knowledgebase and rules files for POSE.

After installation POSE allows the user to either index all the files on the device or to select those folders or files they wish to index. POSE then indexes the content of the device based on the user's selection. After indexing, POSE then starts monitoring the device's storage medium for any changes. POSE monitors changes to the folders on the device and to individual files. If files are modified POSE re-indexes the modified file. If a folder is moved or deleted POSE re-indexes to account for the change. The monitoring is done in real time so changes appear in real time. Any newly added file to the device is automatically indexed. The user may start searching before indexing is complete.

After indexing the user may continue searching or take the device to another host computer, connect the device and search the device using POSE. The user may also use POSE to index the host computer to which the device is connected. Since everything is a device, POSE does not see a difference between a desktop, a laptop, a camera, an MP3 or a cell phone.

Multiple Devices Support

POSE supports searching of multiple devices. When a POSE-enabled device is connected to a host, POSE checks the device and the host for their identity and decides how to interact with the host based on the information in the device's registries and the host's MAC Address. The POSE start daemon checks to see if POSE is installed on the host. If it is and the instance of POSE is already running on the host, the device does not start another instance of POSE from the newly connected device but instead sends a message to the already running instance. The message includes:
the newly connected device's index location;
the data category files on the device;
location of the saved searches on the device;
the device's device registry database;
device knowledgebase;
the device's rules files; and
the device's profile name.

The running instance on the host then adds the device's name and its index to a list of devices and sources and updates the POSE user interface to visually show the user the newly added device. When the user searches they will be searching both the host computer's index and the newly added device's index. POSE imposes no limits as to the number of devices that can be added. If there are no matches between the host computer's unique ID and the software license POSE will notify the user that there is no match between the device and the host and will assume that the host is either a new machine or the host does not belong to the owner of the device. The user may elect to add a new device and then index and search the host by selecting “Add Device” from the options provided by POSE. If the user selects the “Add Device” option, POSE will go through the installation process—get the device's profile name, unique ID, etc.

POSE supports all the standard search operators—AND, OR, NOT and other extended operators such as Phrase, stemming, proximity, field, date and wildcard searches. The user may use any of these operators just as they would with any other search engine. In addition to this, POSE automatically categorizes the data found on the device and provides configurable categories. Auto categorization means POSE automatically generates categories based on the files found on the device. POSE uses file formats to decide which kinds of formats belong to a category. A file format may belong to one or more categories. The user may override POSE's categorization simply by moving file formats from one category to another. The user may use the POSE default categories or change the category by selecting from the category by deleting, adding or modifying it.

POSE uses the category function to allow users to restrict documents to a particular type with just one click. Clicking on the All Files category without entering a search term displays all the files on a device if only one device is connected or all the files from all the devices if a lot of devices are connected. Clicking on any category with a blank search input box runs a query for all files and then restricts the files to the selected category.

A successful search returns a result set. The result set could come from all the connected devices or from just one device. The result set gives the user an abstract of each document, the document type, a link that opens the directory where the file resides. To retrieve a document, the user clicks on the link for the document. To go to the directory where the file is saved, the user clicks the Open Folder link. To view the document as text, the user clicks View as Text. When the link for a document is clicked, POSE “knows” from the indexing process—the type of document—PDF, Web page, etc. and opens the file using the appropriate application.

POSE uses embedding as a way to manage the viewing of documents. POSE embeds media players and productivity applications so that users do not have to open additional windows to view content. The media players play music, video and movies and the embedded applications allow users to view, read, edit documents in-place.

POSE integrates consumer devices into search. Since POSE runs on any device that has storage capability, POSE identifies and easily downloads data from any of these devices. The data could be manipulated—read, edited, copied, rotated, resized, modified, deleted, searched and saved to another device or to the same device that originally held the data.

POSE has all the advanced search and preferences found in today's desktop search engines such as advanced search and preferences. Advanced search allows users who want more control over the search process to further limit their search using criteria such as date range, document language, restricting search to a certain field, etc.

POSE's preferences allow users to further customize POSE's behavior. POSE makes available the following preferences categories: Statistics, Suspend Indexing, Resume Indexing, Enable Drive Monitoring, Disable drive monitoring, Preferences Files. All the features of POSE are available on every platform and for most devices. The limitation that may arise will be due to the capability of the device rather than to any limitation placed by POSE.

How to Start POSE

Double-clicking on the POSE icon starts POSE. Since POSE handles many devices at once, it is not necessary to manually start POSE on each device. POSE has a start daemon that polls all connected devices and automatically starts POSE on devices. With the daemon, the user need only start POSE once and any other device that is connected is started automatically by POSE.

POSE Search

POSE was designed to address the simultaneous searching of multiple independent indexes. It has advanced search capabilities beyond those found on the standard desktop search engines of today:

Federated searching: The ability to search multiple independent devices or drives simultaneously; The ability to present a combined result set or result set from independent devices attached to a host computer; Listing of available devices in the search User Interface so searches can be restricted to a drive or a combination of drives. No existing search engines use devices or drives as a search restrictor; and Categorization of data found on the device: POSE categorizes the data found on a device so users can restrict their searches to the categories.

Instance Handover: When multiple devices are connected only 1 user interface is active and that one user interface is what is used to search all the connected devices. Since POSE runs from portable drives or devices that can be unplugged at any time, POSE creates a virtual search manager on a host computer and runs all connected POSE-enabled devices from this virtual search manager. The virtual search manager is basically a list of dynamic symbolic links that are generated by POSE. POSE creates a dynamic symbolic link for each connected device. Each link points to the following resources on each device:
The devices device registry so POSE can determine ownership, know which mode to run in, import the device name and add it to the Devices Information and to the Devices Available for Searching user interfaces
The device's license file so POSE can determine licensing information and know whether to add the device to the list of devices available for searching if the user is within the limits of his/her license or let the user know that they have exceeded the allotted license and need to obtain more licenses
The device's knowledgebase so POSE can determine what kind of device it is, the device's capability and what processing logic to apply to the device
the device's rules file so POSE can determine additional restrictions and processing rules for the device
The device's index so POSE knows where to look for it to search it
The saved searches on the device so POSE can import them and add them to the search user interface to make them available for use
The categories associated with the device so POSE can import them and make them available to the user
The excluded files for the device so POSE can exclude them from searching

When the device is unplugged POSE removes the dynamic symbolic link and in effect removes all the information for a device from searching and indexing. POSE works the same way for indexing as it does for searching. When a device is connected POSE goes through its usual checks for ownership, license information as outlined earlier and then instead of creating a dynamic symbolic link, spurns a thread to index the device. So each device is independently indexed whether connected to other devices or when operating in a stand-alone mode.

Application-level security: POSE accepts connections only from the localhost. All External connections are denied.

POSE has the ability to automatically import indices without human intervention from all the POSE-enabled devices—devices that have POSE installed on them.

POSE provides the ability to restrict searching to only one or x number of devices. In a multi device environment, users may want to limit searches to only the device that has the data they are looking for. POSE allows this by allowing users to restrict a search to a device using the device name. In POSE, device names are tied to the device's index so selecting a device name is the equivalent of selecting an index. It is preferable to use a device name to do the restrictions because a device name will be easier for users than an index name.

POSE provides support for single application. When one instance (copy) of POSE is running and another POSE-enabled device is plugged in, another POSE instance will not start, instead a message will be sent to the already running instance. The already running instance will then read the index of the newly plugged—in device, import its index and add the device's name to the list of connected devices in the search interface. This way, regardless of how many portable devices are connected, only one interface is needed to read all the indices, list all connected devices, search all the devices and display the result set for all the connected devices.

The POSE User Interface

POSE could use a Graphical User Interface (GUI) or a standard Web browser for its User Interface. POSE does not have its own built-in browser but calls and uses the default browser found on the host computer that the portable drive or device is connected to. Because of its portability POSE makes no assumptions about the browser on the host computer and as a result can use any browser. Although POSE depends on the browser on a host computer, POSE also has its own custom GUI that is cross-platform. POSE can use this GUI when it has to.

Making devices work as peers. Attached devices will communicate with each other to share device registry, knowledgebase, rules, and licensing information among others.

The foregoing and other objects and advantages will appear from the description to follow. In the description reference is made to the accompanying drawings, which forms a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawings, like reference characters designate the same or similar parts throughout the several views.

The following detailed description is, therefore, not to be taken in a limiting sense, and the scope of the present invention is best defined by the appended claims.

### BRIEF DESCRIPTION OF THE DRAWING FIGURES

In order that the invention may be more fully understood, it will now be described, by way of example, with reference to the accompanying drawing in which:

FIG. 1 is an illustrative view of the present invention;

FIG. 2 is an illustrative view of smart devices having the present invention installed thereon;

FIG. 3 is a partial list of devices that can employ the portable search engine;

FIG. 4 is an illustration of the present invention verses prior art;

FIG. 5 is a chart of data structures maintained by the present invention;

FIG. 6 is a flowchart of the installation of the present invention;

FIG. 7 is a flowchart of the indexer and crawler processes of the present invention;

FIG. 8 is a flowchart of the extracted data category assignment of the present invention;

FIG. 9 is a flowchart of the search process of the present invention;

FIG. 10 is a flowchart of the indexing process of the present invention;

FIG. 11 is an illustrative view of a device having the portable search engine software thereon;

FIG. 12 is an illustrative view of devices capable of sharing data using the present invention; and

FIG. 13 is an illustrative view of devices in a network searchable by a single occurrence of the portable search engine on another device.

### DESCRIPTION OF THE REFERENCED NUMERALS

Turning now descriptively to the drawings, in which similar reference characters denote similar elements throughout the several views, the Figures illustrate he portable search engine (POSE) of the present invention. With regard to the reference numerals used, the following numbering is used throughout the various drawing figures.
10 Portable Search Engine (POSE) of the present invention
12 operating system devices
14 electronic storage devices
16 POSE generated data

### DETAILED DESCRIPTION OF THE PREFERRED EMBODIMENT

The following discussion describes in detail one embodiment of the invention. This discussion should not be construed, however, as limiting the invention to those particular embodiments, practitioners skilled in the art will recognize numerous other embodiments as well. For definition of the complete scope of the invention, the reader is directed to appended claims.

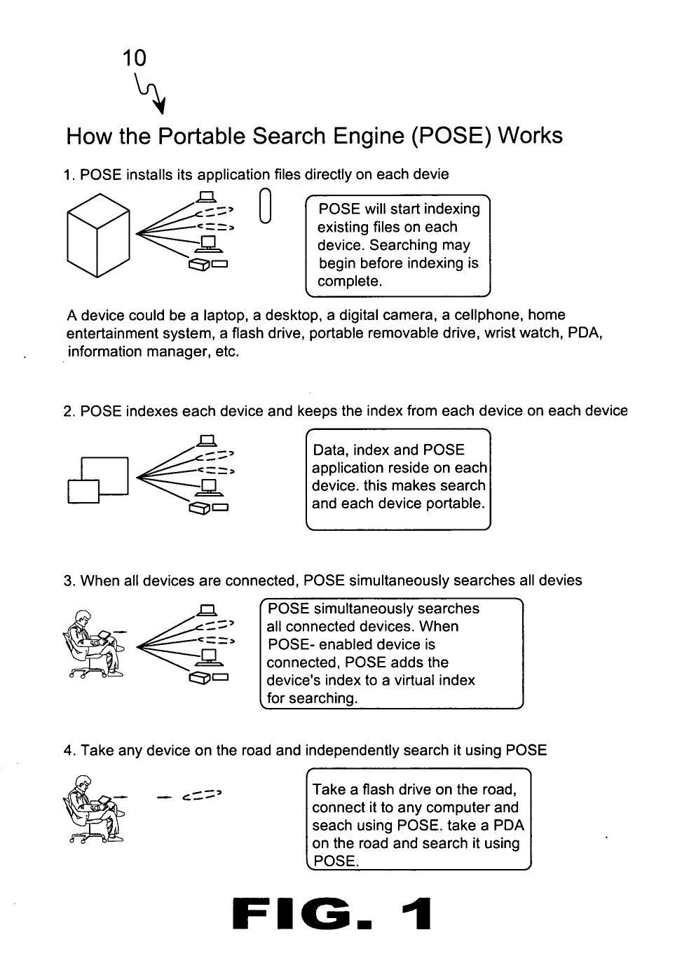

Referring to FIG. 1, shown is an illustrative view of the present invention comprising a portable search engine POSE installable on each device. Once installed on a device, the POSE (10) process is started by double-clicking on the POSE icon, which starts POSE. Since POSE handles many devices at once, it is not necessary to manually start POSE on each device. POSE has a start daemon that polls all connected devices and automatically starts POSE on devices. With the daemon, the user need only start POSE once and any other device that is connected is started automatically by POSE. During installation, POSE asks the user to give the device a profile name. The user then enters a descriptive name for the device. POSE then queries the device for a unique identifier. For desktops and laptops POSE uses their machine address (MAC ID). For other devices, POSE queries the devices for their vendor ID and serial number. POSE combines the vendor ID and serial number and uses these as a unique identifier for the device. For devices that do not have a MAC address or a vendor ID and serial number, POSE generates a unique number. The unique identifier is then tied to the profile name given to the device and stored in the device registry. POSE searches the device registry for a list of registered devices on startup and if the device's ID is in the registry POSE indexes and searches the device and if not, POSE runs as an independent operating environment using the host's memory, processor, keyboard and monitor but does not try to index or search the host. After entering the device's profile name and unique ID in the device registry, POSE checks the license file to ensure the user's license has not expired and the user has not exceeded their allotted license. IF the license is still valid, POSE checks the number of connected devices to make sure that the number of connected devices have not exceeded their number allowed in the license. If the number of connected devices is within limits, POSE checks the device knowledgebase to retrieve information for the device and also checks the rules file associated with the device. POSE then installs itself and starts indexing documents or starts monitoring the device for changes if POSE has already been installed. POSE monitors changes to the folders on the device and to individual files. If files are modified POSE re-indexes the modified file. If a folder is moved or deleted POSE re-indexes to account for the change. The monitoring is done in real time so changes appear in real time. Any newly added file to the device is automatically indexed. The user may start searching before indexing is complete. After indexing the user may continue searching or take the device to another host computer, connect the device and search the device using POSE.

The user may also use POSE to index the host computer to which the device is connected. Since everything is a device, POSE does not see a difference between a desktop, a laptop, a camera, an MP3 or a cell phone.

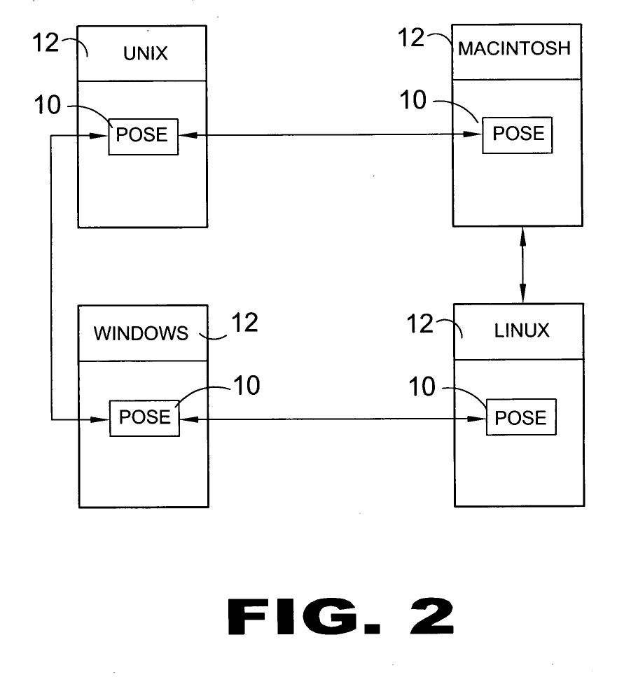

Referring to FIG. 2, shown is an illustrative view of smart devices having the present invention installed thereon. POSE (10) is designed to be able to interchange search information on the different operating systems (12). This means a user can use any device on any operating system and be able to use POSE to search the device. For example, a user can search a UNIX or Macintosh device from Windows using POSE. This is possible if POSE is installed on the UNIX and Macintosh computers and they are all connected via a network.

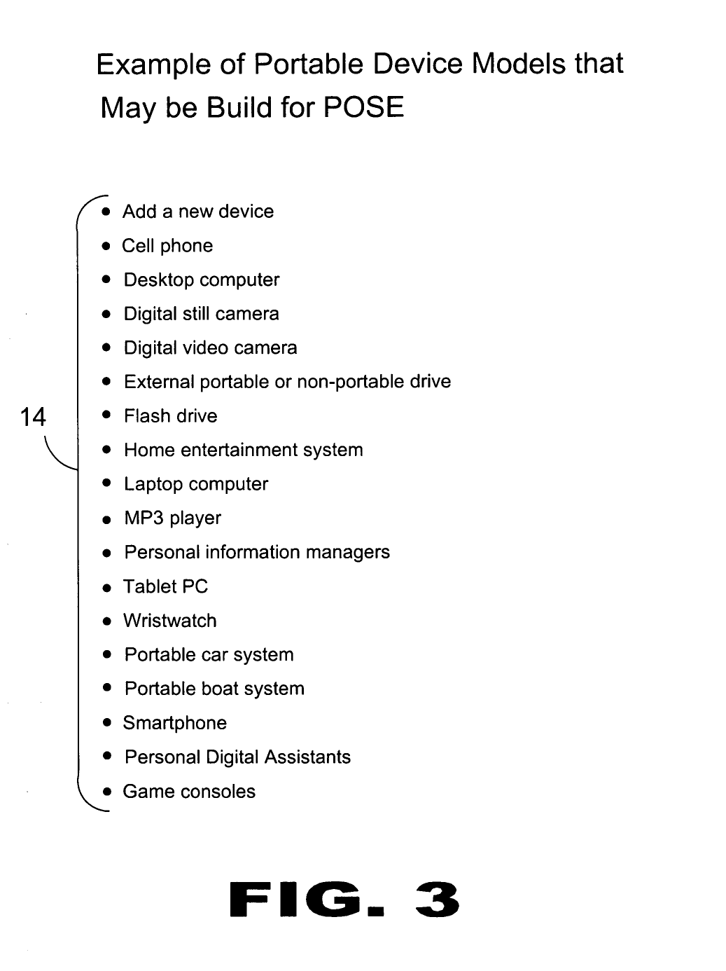

Referring to FIG. 3, shown is a partial list of devices that can employ the portable search engine. POSE (10) works on dumb and smart devices (14). A dumb device (14) is a device that has no processor, system memory, graphics card, networking or display capabilities of its own. An example of a dumb device is an external disk drive. When installed on a dumb device, POSE must be connected to a host in order for it to work. When connected to a host (12), POSE uses the host's processor, system memory, graphics card, networking and display. When installed on a smart device, POSE uses the smart devices processor, system memory, graphics card, networking and display.

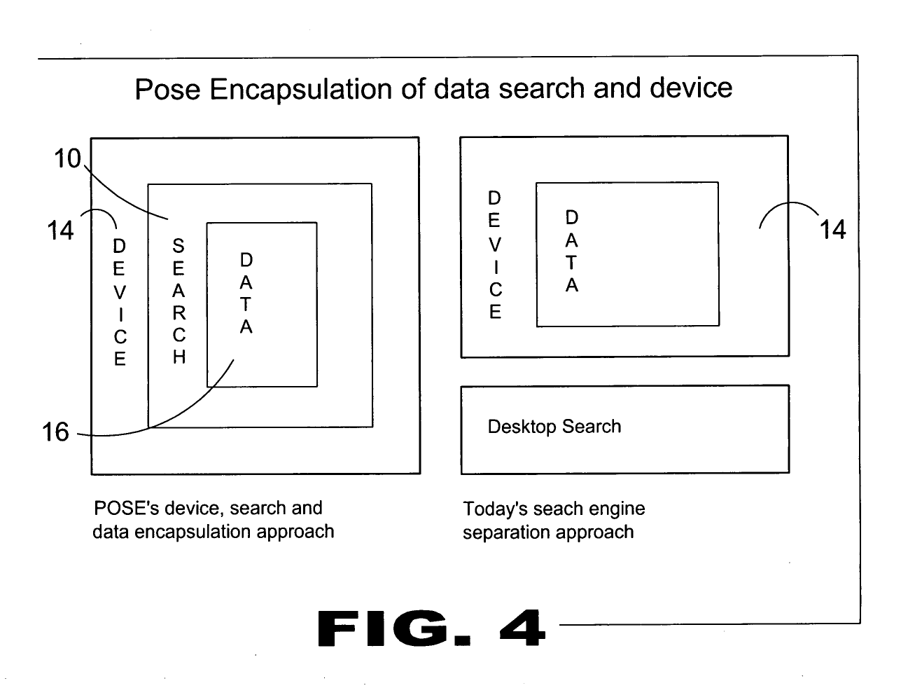

Referring to FIG. 4, shown is an illustration of the present invention verses prior art. POSE (10) is a portable search engine that can be installed on user devices (14) and be searched with ease regardless of where the user is. Unlike the search engines of today that store all their application data and the generated indices on the desktop, POSE installs and saves all files (16) relating to a device on the device itself. As a search platform users can search all the devices they own—cell phones, flash drives, digital cameras, personal digital assistants, desktop and laptop computers, etc.—simultaneously. The idea is that the user simply plugs in the device and searches—it does not matter whether the device is a wristwatch, cellphone or home computer. Incorporating an intelligence layer allows it to know who owns each device so as to know how to behave when used at home or on the road. The intelligence layer is comprised of Federation of devices, device registry, device knowledgebase, device rules database, license manager and a connectivity and an e-commerce layer.

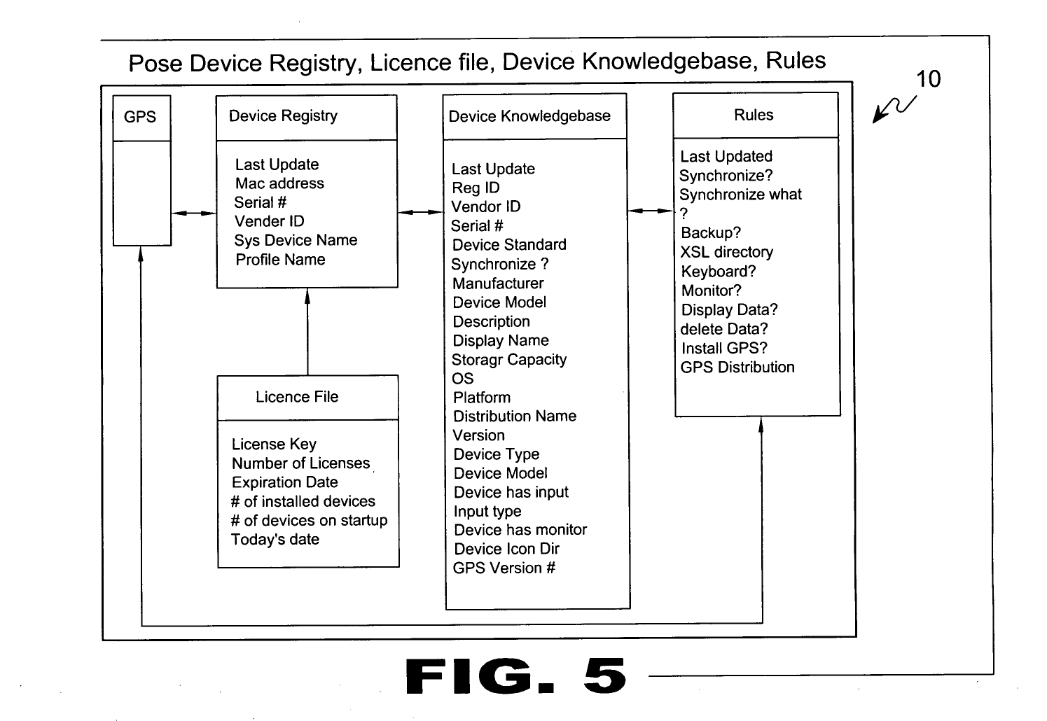

Referring to FIG. 5, shown is a chart of data structures maintained by the present invention. To intelligently manage the flow of information within and among devices and between devices that are connected to public information systems, POSE (10) creates a series of device registries, federation of devices, device knowledgebase and rules files. Collectively these files moderate the exchange of data among devices, identify device owners, define what a device is and what its capabilities are and help to enable data conversion from one device's format to another.

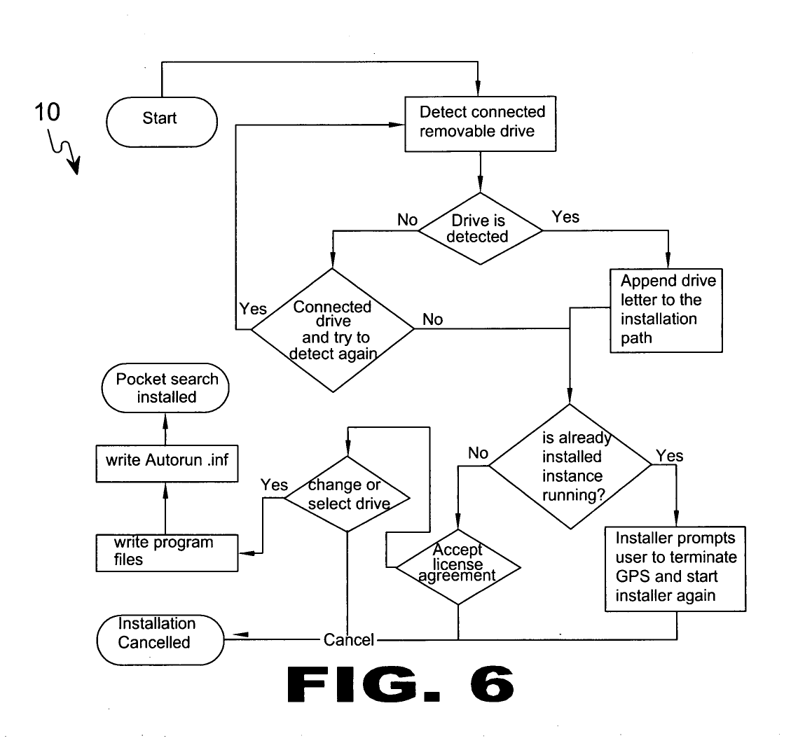

Referring to FIG. 6, shown is a flowchart of the installation of the present invention. During installation, POSE (10) asks the user to give the device a profile name. The user then enters a descriptive name for the device. POSE then queries the device for a unique identifier. POSE searches the device registry for a list of registered devices on startup and if the device's ID is in the registry POSE indexes and searches the device and if not, POSE runs as an independent operating environment—uses the host's memory, processor, keyboard and monitor but does not try to index or search the host. After entering the device's profile name and unique ID in the device registry, POSE checks the license file to ensure the user's license has not expired and the user has not exceeded their allotted license. If the license is still valid, POSE checks the number of connected devices to make sure that the number of connected devices have not exceeded their number allowed in the license. If the number of connected devices is within limits, POSE checks the device knowledgebase to retrieve information for the device and also checks the rules file associated with the device. After this, POSE installs itself and starts indexing documents or starts monitoring the device for changes if POSE has already been installed.

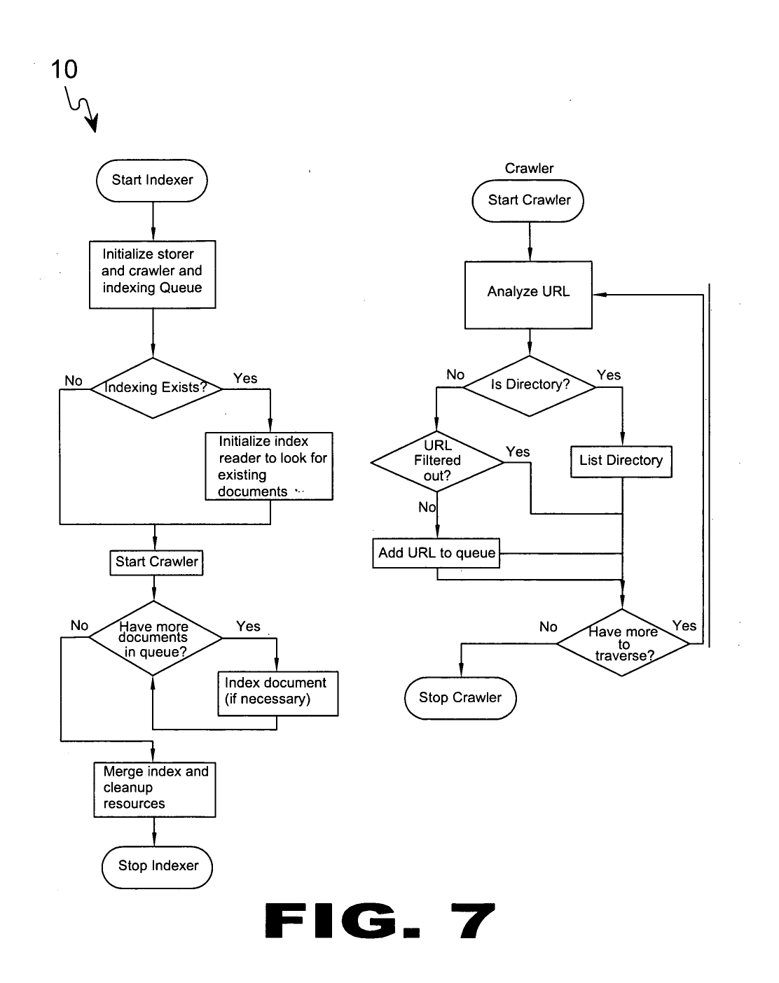

Referring to FIG. 7, shown is a flowchart of the indexer and crawler processes of the present invention. The portable search engine (10) provides a cross-platform indexer process comprising a craweler process and a storer process that indexes documents after they have been parsed and indexes documents and uses the documents to create an index.

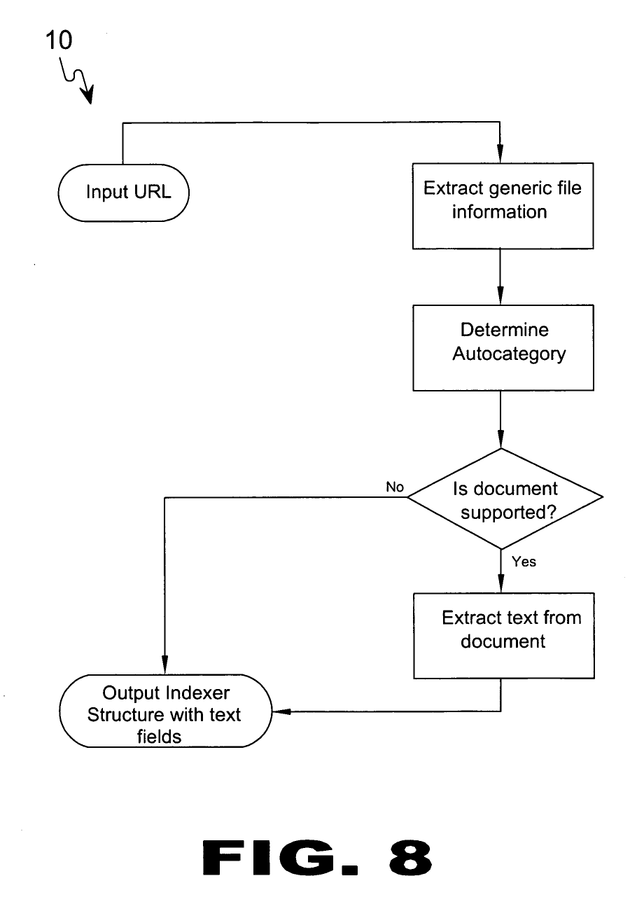

Referring to FIG. 8, shown is a flowchart of the extracted data category assignment wherein POSE (10) automatically categorizes the data (16) found on a device and provides configurable categories. Auto categorization automatically generates categories based on the files found on the device. POSE uses file formats to decide which kinds of formats belong to a category. A file format may belong to one or more categories. POSE uses the category function to allow users to restrict documents to a particular type with just one click. The user may use the POSE default categories or change the category by selecting from the category by deleting, adding or modifying it.

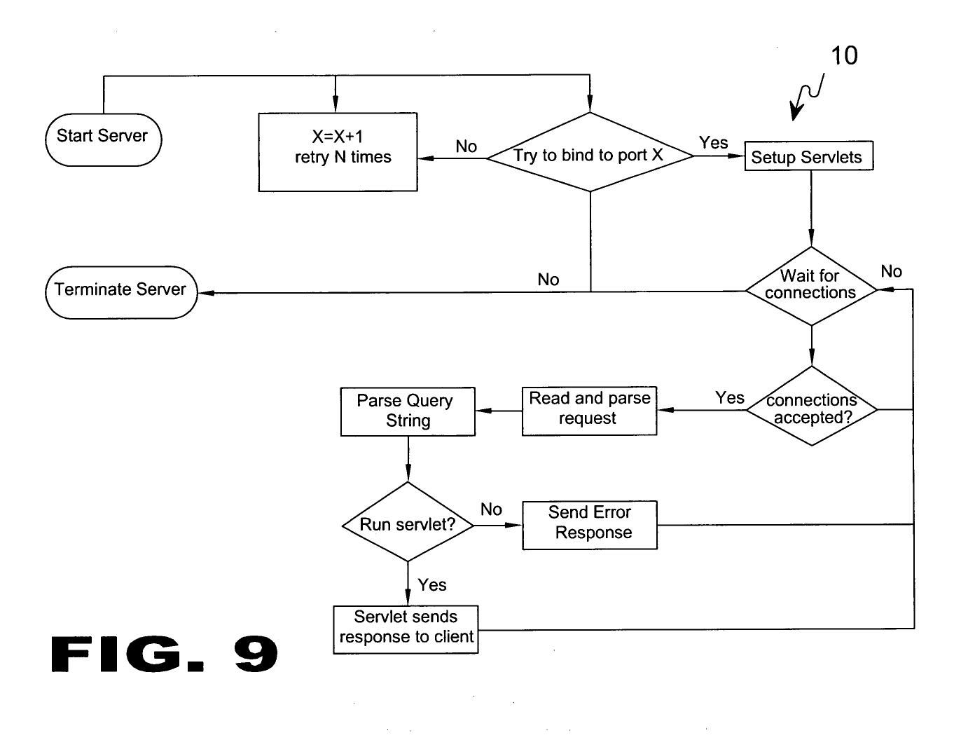

Referring to FIG. 9, shown is a flowchart of the search process of the present invention. The search process (10) returns a result set that could come from all the connected devices or from just one device. To retrieve a document, the user clicks on the link for the document. To go to the directory where the file is saved, the user clicks the Open Folder link. To view the document as text, the user clicks View as Text. When the link for a document is clicked, POSE knows from the indexing process the type of document—PDF, Web page, etc. and opens the file using the appropriate application. POSE uses embedding as a way to manage the viewing of documents. POSE embeds media players and productivity applications so that users do not have to open additional windows to view content. The media players play music, video and movies and the embedded applications allow users to view, read, edit documents in-place. POSE integrates consumer devices into search. Since POSE runs on any device that has storage capability, POSE identifies and easily downloads data from any of these devices. The data could be manipulated—read, edited, copied, rotated, resized, modified, deleted, searched and saved to another device or to the same device that originally held the data. POSE has all the advanced search and preferences found in today's desktop search engines such as advanced search and preferences. Advanced search allows users who want more control over the search process to further limit their search using criteria such as date range, document language, restricting search to a certain field, etc.

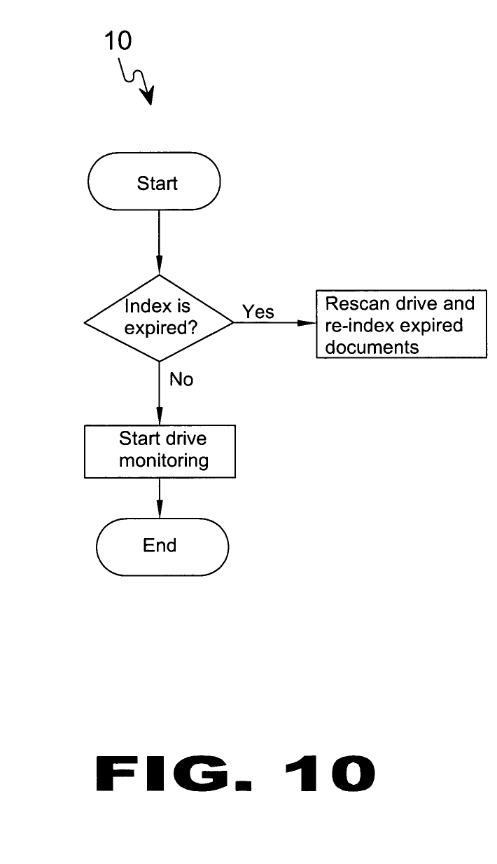

Referring to FIG. 10, shown is a flowchart of the indexing process of the present invention. After indexing, POSE (10) starts monitoring the device's storage medium for any changes. If files are modified POSE re-indexes the modified file. If a folder is moved or deleted POSE re-indexes to account for the change. The monitoring is done in real time so changes appear in real time. Any newly added file to the device is automatically indexed. The user may start searching before indexing is complete.

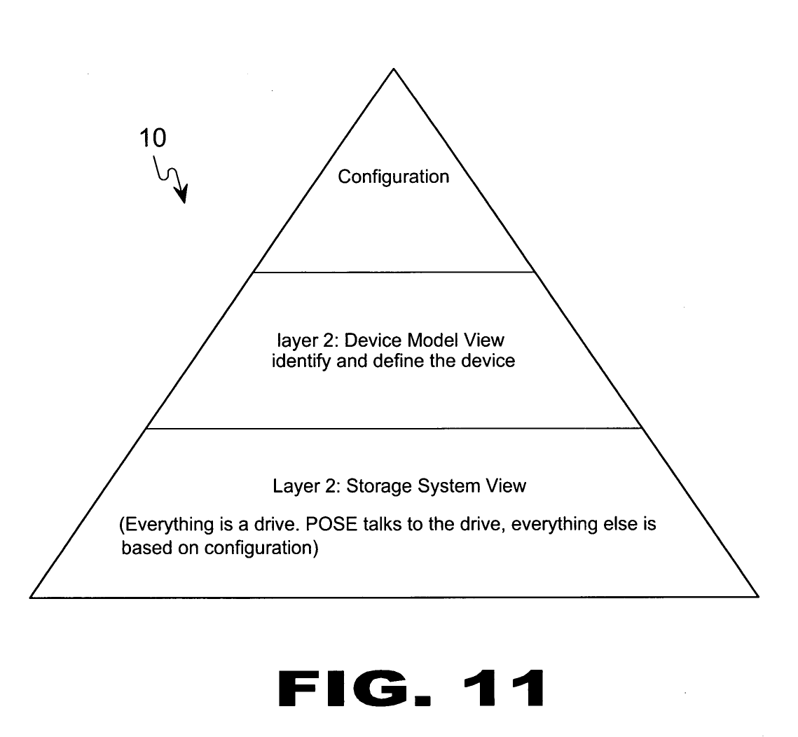

Referring to FIG. 11, shown is an illustrative view of a device having the portable search engine software thereon. Because all devices have storage that store the same kind of data, POSE's (10) design mandates the storage, not the operating system, as the basic unit of design. Consequently, POSE runs on anything that has storage—it does not matter what kind of storage. POSE then builds a model of a device on the storage framework. With this approach anything can be defined on top of the storage foundation. In POSE's view, the operating system is one configuration option among many.

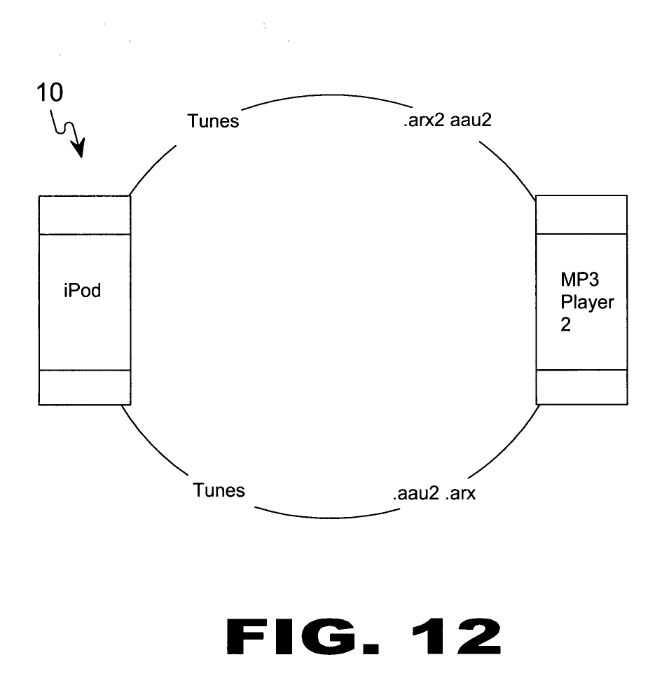

Referring to FIG. 12, shown is an illustrative view of devices capable of sharing data using the present invention. POSE (10) has three modes of working: Home Mode, Away Mode: Stand-alone mode. In Home Mode POSE shares data with all the hosts it is connected to. In this mode the host is considered private and POSE has determined that all the connected devices are owned by the same person. POSE uses the information obtained from its device registry to determine whether it is operating in home mode—connected to a host that belongs to the same person who owns the devices that are connected to the host. Even though there may be six or more connected devices, only one instance of POSE will be running because POSE automatically handles how many instances are running. In the home mode only one instance will run since all devices belong to the same person and it is all right to see and share all the information on the devices. Away Mode, Connected: In this mode POSE considers itself in away mode if it does not find the profile of the computer it is running on in its device registry. In this mode, POSE uses the host to create an isolated working environment. POSE runs strictly from the device but uses the host's resources such as the host's monitor, browser, and applications needed to show data but nothing is saved on the host. POSE does not share information with the host. If the host also has POSE installed, the POSE running on the device will not combine its instance with that of the one running on the host. Instead, POSE on the device will run from the device. The reason for this is that the POSE on the public host and the POSE on the device belong to different people. In Away Mode, Stand-alone: This mode is for smart devices like Smartphones that have keyboards, memory, processor and display capability. POSE is not connected to any host (private or public) so it depends entirely on the files on the device.

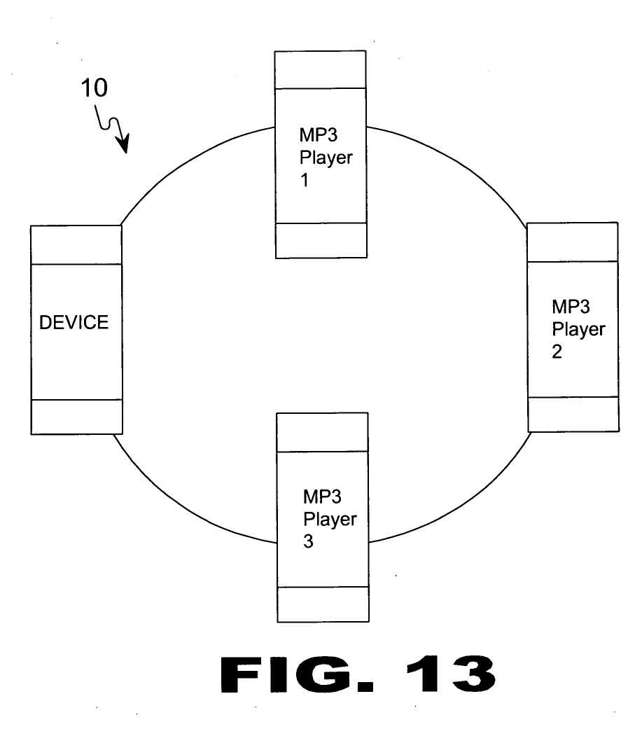

Referring to FIG. 13, shown is an illustrative view of devices in a network searchable by a single occurrence of the portable search engine on another device. POSE (10) has 3 modes of working: Home Mode, Away Mode: Stand-alone mode. In Home Mode POSE shares data with all the hosts it is connected to. In this mode the host is considered private and POSE has determined that all the connected devices are owned by the same person. POSE uses the information obtained from its device registry to determine whether it is operating in home mode—connected to a host that belongs to the same person who owns the devices that are connected to the host. Even though there may be 6 or more connected devices, only one instance of POSE will be running because POSE automatically handles how many instances are running. In the home mode only one instance will run since all devices belong to the same person and it is all right to see and share all the information on the devices. Away Mode, Connected: In this mode POSE considers itself in away mode if it does not find the profile of the computer it is running on in its device registry. In this mode, POSE uses the host to create an isolated working environment. POSE runs strictly from the device but uses the host's resources such as the host's monitor, browser, and applications needed to show data but nothing is saved on the host. POSE does not share information with the host. If the host also has POSE installed, the POSE running on the device will not combine its instance with that of the one running on the host. Instead, POSE on the device will run from the device. The reason for this is that the POSE on the public host and the POSE on the device belong to different people. In Away Mode, Stand-alone: This mode is for smart devices like Smartphones that have keyboards, memory, processor and display capability. POSE is not connected to any host (private or public) so it depends entirely on the files on the device.

What is claimed is new and desired to be protected by Letters Patent is set forth in the appended claims:

1. A device independent portable distributed search engine (POSE) system and method that installs and runs on any device including a dumb device like a flash drive, an external drive or a smart device like a desktop computer, a laptop, personal digital assistant, wrist watch, home entertainment system, video camera, tablet PC, etc. comprising:
a) storing application files and user generated files on a device's storage media instead of the operating system's registries and resources;
b) treating the device's storage media as the operating system;
c) a file-based device registry that allows POSE to register devices so it knows which devices to search and which ones to ignore;
d) a device knowledgebase that allows POSE to know the capabilities of the devices to be indexed and searched;
e) rules that tell POSE what it can and cannot do with each device;
f) a cross platform index that is not binary tied to any specific operating system;
g) a file system-mirror-based index that mirrors and monitors the actual operating system's filesystem;
h) dynamic symbolic links to point to all the individual indices running on all connected devices for searching;
i) a device-based federated search engine to search all the independent indices running on each device;
j) a file-based startup; and
k) an access layer to access non-accessible storage devices.

2. The method and system as recited in claim 1, wherein the search engine searches the index on portable or non-portable devices or drives.

3. The method and system as recited in claim 1, including a standard search platform that runs natively on all major operating systems including Windows, Linux, Macintosh, UNIX, portable operating systems such as PalmOS, Windows Mobile and on embedded systems wherein POSE can read its index on all these platforms and so can share its data across platforms.

4. The method and system as recited in claim 1, including a process for encapsulating search engines, data and devices by installing POSE on any device such as dumb devices including external drives, flash drives and smart devices including desktop computers and cell phones, creating a search unit that can be searched independently or collectively including independent search units or devices that can be chained together and searched collectively.

5. The method and system as recited in claim 1, providing a portable, distributed device-based search engine that can store its index on another device rather than the device on which the search engine is stored, as opposed to the prior art approach of search engines that index devices but keeps the indices from the devices on the desktop, whereby POSE can index a host computer (desktop or laptop computer or any other host) and keep the index either on the host computer or on another device so that the host is then searchable when the device is connected to the host.

6. The method and system as recited in claim 1, wherein a portable federated search engine searches multiple connected drives or devices simultaneously.

7. The method and system as recited in claim 1, wherein a copy of a shared index is stored onto a portable device including a portable drive, an embedded drive, a mobile manager, personal digital assistant, a wristwatch and any other device incorporating an electronic storage media.

8. The method and system as recited in claim 1, wherein the device registry, the device knowledgebase, the license file and the rules file work together to create modes of operation: Home mode, Away mode and Stand-alone mode.

9. The method and system as recited in claim 1, wherein connected devices are started automatically, where a dynamic symbolic link points to indices, saved searches, data categories, device registry and all the relevant files on connected devices

10. The method and system as recited in claim 1, wherein data is indexed in memory either on the device, a host computer or any number of devices and then written to disk.

11. The method and system as recited in claim 1, wherein the results of a federated search are combined either on the device, a host computer or any number of devices and returned as one result set.

12. The method and system as recited in claim 1, wherein the results of a federated search are combined and or sorted either on the device, a host computer or any number of devices and returned individually for each searched device.

13. The method and system as recited in claim 1, wherein the results of a federated search are combined and or sorted either on the device, a host computer or any number of devices and returned individually for each searched source, wherein said source could be an internal or external database or an internal or external website or source of data.

14. The method and system as recited in claim 1, wherein the search engine can search internal and external sources of data from a portable device including the Web, internal or external databases or any other source of data.

15. The method and system as recited in claim 1, wherein the portable search engine operates independently on each device or drive and can communicate with, and if necessary, defer to another occurrence of the search engine in a federation of devices comprising a collection of multiple POSE-enabled connected devices working together.

16. The method and system as recited in claim 1, wherein search, language and custom configuration files are stored on each individual device and can be indexed and searched independently.

17. The method and system as recited in claim 1, further providing a POSE generated unique ID for each index with the ID constant for each index whereby,
a) The ID is returned along with a document when user searches; and
b) Using the ID as a key, POSE can recover the drive letter using the algorithm: Index 1 ID: P1kAlMiG; Index 2 ID: S6fL34GY, that when a document is returned, the document will have a field called index ID which contains the value of the generated ID for that index so that when another instance of POSE is started, POSE passes a pair of index ID and drive letter, so that with this information POSE can later restore drive letter during search.

18. The method and system as recited in claim 1, providing portable, distributed, cross-platform Unicode parsers that parse words on devices.

19. The method and system as recited in claim 1, including a “subscription layer” that:
a) manages all the data that is needed to connect to a site and retrieve information with the subscription layer containing a user's user name and password, the URL to a site, the user's license information and any other information the user will need to connect to and retrieve information from a paid or protected site
b) allows the user to enter all the information related to logging on and retrieving information from a site once whereby POSE saves this information and automatically logs on and downloads the data for the user;
c). the subscription layer could be used for one or many sites;
d). the subscription layer is also used for managing paid subscription service(s) on a transactional, monthly, or yearly subscription basis from a portable device; and
e) the professional information band allows POSE to manage paid subscriptions for journals, books, magazines, or other types of paid information with all data related to the subscription layer encrypted by POSE.

20. The method and system as recited in claim 1, wherein the indexer is able to index network and local drives, databases and the Internet from a portable device or drive.

21. The method and system as recited in claim 1, wherein the search engine searches the self-contained index on a portable device or drive.

22. The method and system as recited in claim 1, including a search server that resides on a portable device or drive and binds either to a localhost or to some other protocol outside of the device.

23. The method and system as recited in claim 1, further providing a portable document URL for retrieving documents from portable and other external sources from a device.

24. The method and system as recited in claim 1, further comprising a process for adding one or more indices to a list of indices that will be made available for searching in a collection of devices.

25. The method and system as recited in claim 1, further comprising a process for removing one or more indices from the list of available indices on devices.

26. The method and system as recited in claim 1, further comprising a process for regenerating indexes on portable devices or drives.

27. The method and system as recited in claim 1, further comprising a unique identifier for a host that allows POSE to identify a device and therefore allow or prevent POSE from searching or indexing the contents of the host or device.

28. The method and system as recited in claim 1, further comprising a path convert process that converts absolute paths on devices or drives to relative paths that ensures relative paths are transformed into the absolute paths that are required to retrieve data from the file system so that when drive letters are not constant for portable drives or devices, such as, a portable drive that may be identified as drive “E” at one time but then referred to as drive “N” the next whereby saving the absolute path of a file in the index will cause search retrieval errors and the path convert process also reverses this process when necessary.

29. The method and system as recited in claim 1, wherein the device knowledgebase contains the capabilities of the device.

30. The method and system as recited in claim 1, further providing the ability to connect to local drives from portable, removable and embedded systems.

31. The method and system as recited in claim 1, providing an auto-run search engine and indexer for devices.

32. The method and system as recited in claim 1, further providing drive monitoring on all devices but desktop and laptop computers and drive monitoring on desktop and laptop computers from other devices.

33. The method and system as recited in claim 1, further providing browser activation from portable, removable drives.

34. The method and system as recited in claim 1, providing portable search server that runs on devices.

35. The method and system as recited in claim 1, further comprising a POSE On-the-fly indexing of contents on devices.

36. The method and system as recited in claim 1, further comprising a POSE process for automatic categorization of data on devices and for merging categories across devices.

37. The method and system as recited in claim 1, further comprising a process to automatically update distributed indices in real-time using wireless or wired connection.

38. The method and system as recited in claim 1, further comprising a process for real-time update of distributed indices on devices running on a single platform, for example, Linux or Windows or Macintosh or UNIX.

39. The method and system as recited in claim 1, further comprising a POSE process for real-time update of distributed indices on devices running on multiple platforms, for example a combination of Linux, Windows, Macintosh, UNIX, PalmOS, BSD, Windows Mobile, Symbian, etc.

40. The method and system as recited in claim 1, further comprising a POSE process to use a custom Graphical User Interface or a browser to display results and documents from a portable device or drive.

41. The method and system as recited in claim 1, providing a portable, distributed, cross-platform index that stores words extracted from devices and also contains file system information such as file system structure with the index in addition to holding words and pointing to which documents the words could be found in and where the documents reside, the index also mirrors the file system.

42. The method and system as recited in claim 1, providing a portable, distributed, cross-platform indexer comprising a craweler part and a storer that. indexes documents after they have been parsed and indexes documents and uses the documents to create an index.

43. The method and system as recited in claim 1, providing a portable, distributed, cross-platform crawler that traverses the drive directory tree, reads all files in the directory and passes them to the indexer.

44. The method and system as recited in claim 1, wherein said portable device crawler crawls the directories in alphabetical order starting with the “C” drive on Windows or “/”, the root directory in Linux, UNIX and Mac, and crawls its way down the list of drives or file system with the craweler as single threaded on devices that lack multiple threading support or using multiple threads to crawl multiple drives simultaneously on devices with multiple threads support.

45. The method and system as recited in claim 1, further comprising a POSE, distributed, cross-platform device analyzer, which is a part of the indexer, that tokenizes text, parses queries and excludes stop words by functioning as follows:
a) during indexing, the analyzer is responsible for tokenizing text into terms for storing into index;
b) during searching the analyzer is used to parse queries; and
c) excluding stop words from inclusion in the index by referencing the stop word file to determine which words are considered stop words.

46. The method and system as recited in claim 1, wherein said portable, distributed, cross-platform Storer running on devices that works in concert with said crawler and analyzer to actually index the documents it receives in internal format and store them in the index and uses said Analyzer to tokenize text into terms.

47. The method and system as recited in claim 1, further comprising a portable, distributed, cross-platform Re-index Interval that specifies the amount of time to wait until the next time POSE will scan a device's drive/filesystem for changes having a configurable parameter that can be changed from the POSE.

48. The method and system as recited in claim 1, wherein the POSE process can remove an index from devices.

49. The method and system as recited in claim 1, wherein the POSE process searches desktops, laptops and other portable devices from a portable device.

50. The method and system as recited in claim 1, wherein POSE is a dual search engine that can operate as a desktop search engine and as a portable search engine that can be installed on stand-alone devices.

51. The method and system as recited in claim 1, further providing a POSE process for automatically adding devices in real time that have POSE installed on them to a list of devices available for searching or indexing so that when a user plugs a POSE-enabled device into a USB, FireWire or any other connector, POSE will sense the device and will automatically make the device's information available to the user via search and to the indexer.

52. The method and system as recited in claim 1, further providing a POSE process for adding or omitting a device from a query when multiple POSE-enabled devices are connected to a host by:
a) adding the device's index and identifier to the search process;
b) providing a user with a process whereby the device can be eliminated from a search; and
c) maintaining the device's index as part of the general search while eliminating the device's index when the eliminate device from search option is turned on.

53. The method and system as recited in claim 1, further including a POSE process for adding, stopping, pausing a device from indexing comprising:
a) adding the device's index and identifier to the index process when multiple POSE-enabled devices are connected to a host; and
b) providing a process that allows a user to add, stop, pause the device from an indexing wherein;
i) adding allows the user to add a device to POSE's index queue;
ii) stopping stops POSE from indexing the device;
iii) pausing pauses the indexer and the device is not indexed and allows the user to Resume indexing if the device is paused.

54. The method and system as recited in claim 1, further comprising a POSE process for searching desktop, laptop and network devices.

55. The method and system as recited in claim 1, further comprising a POSE process for indexing remote resources, including local drives, network drives, portable drives attached to a remote resource, from a device.

56. The method and system as recited in claim 1, further comprising a process to install POSE on any device in a multiple device environment when one of the multiple devices is already running POSE.

57. The method and system as recited in claim 1, further comprising a process to manage multiple devices through one instance of POSE however many devices are connected to a host computer, so that only one instance of POSE runs and manages all the other instances.

58. The method and system as recited in claim 1, further comprising a process that independently manages each device at the indexing, updating and search level but collective manages them through one interface at the search level, so that if ten devices are connected, each device monitors its drive, indexes its data independently and updates its index while making its index available for searching.

59. The method and system as recited in claim 1, further comprising a process to incrementally index (index on the fly) any device in a multiple devices environment.

60. The method and system as recited in claim 1, further comprising a process to automatically recognize a newly installed or connected POSE-enabled device and add its resources including device name, device capability and device index to the list of available devices in real time.

61. The method and system as recited in claim 1, further comprising a POSE process to search the Web from devices.

62. The method and system as recited in claim 1, further comprising a virtual search manager as a temporary space created on a host computer from where all the resources including pointers or links to the indices and configuration files of all the connected devices and drives are managed, whereby:
a) running all the devices from a virtual search manager on the host eliminates the bottleneck that will occur if a portable device is used to manage other portable devices;
b) unplugging a portable device that is used as a virtual search manager practically kills all the processes that the other devices need and effectively stops all the other devices, so that using a host-based virtual search manager eliminates this problem;
c) the host-based virtual search manager removes all the links and pointers related to a device as the device is shut down; and
d) when the last device is removed, POSE removes the temporary directory from the host.

63. The method and system as recited in claim 1, further comprising a devices knowledgebase that allows POSE to know the capabilities of a device such as the input and output devices available on a device; the amount of storage space, memory, type of device, name of device, manufacturer, model and other pertinent information relating to the device.

64. The method and system as recited in claim 1, further comprising a POSE tool bar framework for managing different data types, post search, whereby the POSE tool bar framework allows POSE to present the user with data-type specific actions they can use to manage data after POSE has retrieved data, as an example, the Photos tool bar will allow users to view photos as slide, print, copy, email, delete and copy photos right from the search interface.

65. The method and system as recited in claim 1, further comprising an auto search/indexer shutdown process so that when a device is pulled from the host without first shutting down the device, POSE will not crash but will gracefully shut down its search and index files and exit cleanly.

66. The method and system as recited in claim 1, wherein the search index is used as secure key by virtue of POSE storing the indexer, index on a portable device which must be connected to a host before the host can be searched, thereby the POSE index becomes the user name/password for searching a host.

67. The method and system as recited in claim 1, further comprising a process for encrypting personal, program and authentication data on POSE, wherein said encryption process is used to encrypt files on the drive in addition to some critical POSE files such as the device registry, the knowledgebase, the license file, the rules file and the subscription layer data that holds users' log on password, user name and other sensitive data.

68. The method and system as recited in claim 1, further comprising a process for gathering Alerts from free and paid information sources on the Web, in corporate databases or from any source, distilling the information and presenting it in a single user interface sorted by source, date, type of information and by priority.

69. The method and system as recited in claim 1, further comprising a process for working with biometric and other authentication systems from a portable device.

70. The method and system as recited in claim 1, further comprising a process for accessing paid information services from a portable device whereby said process combines a Comprehensive Information Database (CIDB), personalization, security, context, authentication, commerce and an Information Provider Domain Service (IPDS).

71. The method and system as recited in claim 1, where search is based on a profile wherein:
a) POSE is a profile-based search engine because it checks all the devices for ownership on startup and before indexing or searching; and
b) checking the device registry for ownership before indexing or searching provides a layer of privacy and security at the search application level.
